(19) United States
(12) Patent Application Publication
(10) Pub. No.: US 2010/0092373 A1
(43) Pub. Date: Apr. 15, 2010

(54) Processes for Removing Carbon Monoxide from a Crude HCl Gas, and HCl Oxidation Processes Using Purified HCl Gas Obtained Thereby

(75) Inventors: Alfred Soppe, Shanghai (CN); Knud Werner, Krefeld (DE)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/579,445

(22) Filed: Oct. 15, 2009

(30) Foreign Application Priority Data
Oct. 15, 2008 (DE) 102008051694.5

(51) Int. Cl. C01B 7/04

(52) U.S. Cl. 423/502

(57) ABSTRACT

The present invention relates to a process for removing gases comprising carbon monoxide from a crude HCl gas which comprises at least carbon monoxide with or without nitrogen, consisting at least of the process steps of:
a) compressing the crude HCl gas to an elevated pressure in a compression stage;
b) cooling the compressed crude HCl gas so as to liquefy hydrogen chloride, leaving the gas comprising carbon monoxide;
c) removing this gas comprising carbon monoxide from the liquefied hydrogen chloride;
d) evaporating the liquid hydrogen chloride and providing it as purified HCl gas for the HCl oxidation process,
   and to an HCl oxidation process coupled to this process.

### BACKGROUND OF THE INVENTION

A multitude of chemical processes for reacting chlorine or phosgene, such as the preparation of isocyanates or chlorinations of aromatics, lead to inevitable occurrence of hydrogen chloride. In general, this hydrogen chloride is converted back to chlorine by electrolysis. Compared to this very energy-intensive method, the direct oxidation of hydrogen chloride with pure oxygen or an oxygenous gas over heterogeneous catalysts (the so-called Deacon process) according to

4 HCl+O₂ [symbol] 2Cl₂+2H₂O

offers significant advantages with regard to energy consumption.

In process steps for preparing isocyanates, such as phosgenation, a relatively large amount of carbon monoxide (CO) may be present as an impurity in the HCl offgas. Typically, hydrogen chloride gas which originates, for example, from a phosgenation reaction comprises carbon monoxide. For instance, EP 0 233 773 states that such a gas may contain up to 10% by volume of carbon monoxide. In the widespread liquid-phase phosgenation, a CO content in the region of 0.1-3% by volume is found in the HCl offgas of the phosgene extractive scrubbing column. In gas phase phosgenation (DE 42 17 019 A1, DE 103 07 141 A1), which has prospects for the future, higher amounts of CO (3 to more than 5%) are also to be expected, since, in this process, preferably no condensation of phosgene, and an associated removal of the carbon monoxide, is performed before the phosgenation.

In conventional catalytic HCl oxidation with oxygen, use is made of a wide variety of different catalysts, for example based on ruthenium, chromium, copper, etc. Such catalysts are described, for example, in DE 1 567 788 A1, EP 251 731 A2, EP 936 184 A2, EP 761 593 A1, EP 711 599 A1 and DE 102 50 131 A1. However, these may function simultaneously as oxidation catalysts for any secondary components present, such as carbon monoxide or organic compounds. However, catalytic oxidation of carbon monoxide to carbon dioxide is extremely exothermic and causes uncontrolled local temperature increases at the surface of the heterogeneous catalysts (hotspots) in such a way that deactivation can take place. Indeed, the oxidation of 5% carbon monoxide in an oxygen-containing inert gas (e.g. N₂) at an inlet temperature of 250° C. (Deacon operating temperatures 200-450° C.) would cause a temperature increase of far greater than 200 K in an adiabatic conversion. One cause of the catalyst deactivation is the microstructural alteration of the catalyst surface, for example by sintering processes, owing to the hotspot formation.

Moreover, the adsorption of carbon monoxide at the surface of the catalyst cannot be ruled out. The formation of metal carbonyls may be reversible or irreversible and is thus in direct competition with the HCl oxidation. Indeed, carbon monoxide can enter into very stable bonds with some elements even at high temperatures and thus cause inhibition of the desired target reaction. A further disadvantage might arise through the volatility of these metal carbonyls, as a result of which not unconsiderable amounts of catalyst are lost and additionally, according to the application, require a complex purification step.

In the case of the Deacon process too, catalyst deactivation can be caused both by destruction of the catalyst and by restriction of stability. Competition between hydrogen chloride and carbon monoxide can also lead to inhibition of the desired HCl oxidation reaction.

The oxidation of hydrogen chloride gas with oxygen is exothermic, and so the temperature rises during the reaction without cooling. This may lead, for example in the case of a catalyst-supported oxidation reaction, to damage to the catalyst as a result of thermal stress. However, the temperature rise can also damage the reactor materials used. In order to prevent this, the reaction chamber can be cooled or the temperature rise can be limited by regulating the amount of hydrogen chloride supplied.

In both cases, a parallel exothermic reaction such as the oxidation of carbon monoxide to carbon dioxide is undesired, since it either increases the cooling performance required or the amount of hydrogen chloride to be oxidized has to be reduced. In the case of use of a ruthenium-based catalyst, it also has to be expected that the carbon monoxide forms volatile carbonyl compounds with ruthenium and the catalytically active component is thus discharged.

For optimal operation of the Deacon process, accordingly, a minimum content of carbon monoxide in the HCl gas is needed in order to ensure a long lifetime of the catalyst used.

The problem of the parallel oxidation of carbon monoxide in hydrogen chloride oxidation has already been discussed in EP 0 233 773 A1 and in JP 62-270404 A. These propose, to solve the problem, a prereaction of the carbon monoxide present in the hydrogen chloride gas with oxygen to give carbon dioxide over a palladium-containing catalyst. However, this solution has the disadvantage that a relatively expensive oxidation catalyst has to be provided and used in a special prereactor.

The application JP 2003-171103 A mentions that, at a high hydrogen chloride content, the palladium catalyst does not possess sufficiently high activity to oxidize the carbon monoxide in the HCl gas. An alternative mentioned there is a catalyst based on ruthenium. This has, however, just like the palladium catalyst, the disadvantage of relatively high cost.

### BRIEF SUMMARY OF THE INVENTION

The various embodiments of the present invention provide effective and simpler processes for purifying a crude hydrogen chloride gas stream.

The invention is based on processes for oxidizing hydrogen chloride by means of oxygen under thermally catalytic conditions and the purification, which is necessary for this purpose, of the reactant gases before contact with the oxidation catalyst.

The invention includes processes for removing gases comprising carbon monoxide, especially nitrogen gas comprising carbon monoxide, from a crude HCl gas which comprises at least carbon monoxide with or without nitrogen and can be used in an HCl oxidation process, the processes including:
a) compressing the crude HCl gas to an elevated pressure in a compression stage;
b) cooling the compressed crude HCl gas so as to liquefy hydrogen chloride, leaving the gas comprising carbon monoxide;
c) removing this gas comprising carbon monoxide from the liquefied hydrogen chloride;
d) evaporating and optionally superheating the liquid hydrogen chloride and providing it as purified HCl gas for the HCl oxidation process.

One embodiment of the present invention includes a process comprising: (a) providing a crude HCl gas comprising hydrogen chloride and carbon monoxide; (b) compressing the crude HCl gas to form a compressed crude HCl gas; (c) cooling the compressed crude HCl gas to form liquefied hydrogen chloride and a gas comprising carbon monoxide; (d) separating the liquefied hydrogen chloride and the gas comprising carbon monoxide; and (e) evaporating the liquefied hydrogen chloride to form a purified HCl gas.

Another embodiment of the present invention includes a process comprising: (a) providing a crude HCl gas comprising hydrogen chloride and carbon monoxide; (b) compressing the crude HCl gas to form a compressed crude HCl gas; (c) cooling the compressed crude HCl gas to form liquefied hydrogen chloride and a gas comprising carbon monoxide; (d) separating the liquefied hydrogen chloride and the gas comprising carbon monoxide; (e) evaporating the liquefied hydrogen chloride to form a purified HCl gas; and (f) feeding the purified HCl gas to an HCl oxidation process.

Yet another embodiment of the present invention includes a process comprising: (a) providing a crude HCl gas comprising hydrogen chloride and carbon monoxide; (b) compressing the crude HCl gas to form a compressed crude HCl gas; (c) cooling the compressed crude HCl gas to form liquefied hydrogen chloride and a gas comprising carbon monoxide; (d) separating the liquefied hydrogen chloride and the gas comprising carbon monoxide; (e) evaporating the liquefied hydrogen chloride to form a purified HCl gas; and (f) catalytically oxidizing the purified HCl gas with oxygen to form chlorine.

In contrast to the processes known from the prior art, the carbon monoxide in the process according to the invention is not removed from the hydrogen chloride gas by an oxidation reaction. Instead, carbon monoxide is removed from the crude HCl gas before it is passed into a Deacon process. To this end, the gas is first compressed and cooled. This liquefies the HCl, but the carbon monoxide remains gaseous. Removal of the gaseous carbon monoxide leaves liquid purified HCl. The liquid purified HCl is subsequently evaporated and conducted into the Deacon process.

### BRIEF DESCRIPTION OF THE SEVERAL VIEWS OF THE DRAWING

The foregoing summary, as well as the following detailed description of the invention, may be better understood when read in conjunction with the appended drawings. For the purpose of assisting in the explanation of the invention, there are shown in the drawings representative embodiments which are considered illustrative. It should be understood, however, that the invention is not limited in any manner to the precise arrangements and instrumentalities shown.

In the drawings:

FIG. 1 is a schematic process diagram in accordance with one embodiment of the present invention; and

FIG. 2 is a comparative schematic process diagram.

### DETAILED DESCRIPTION OF THE INVENTION

As used herein, the singular terms “a” and “the” are synonymous and used interchangeably with “one or more” and “at least one,” unless the language and/or context clearly indicates otherwise. Accordingly, for example, reference to “a crude HCl gas” herein or in the appended claims can refer to a single gas (or gas stream) or more than one gas (or gas stream). Additionally, all numerical values, unless otherwise specifically noted, are understood to be modified by the word “about.”

In various preferred embodiments of the processes of the present invention, the liquefaction of the crude HCl gas is accomplished by the evaporation of the liquid purified hydrogen chloride by passing both streams to the two sides of a heat transferrer operated as a recuperator. The liquid purified HCl is decompressed and then evaporates on one side of the recuperator at a temperature which is lower than the condensation temperature of the crude HCl gas on the other side of the recuperator.

Preference is given to embodiment of the novel processes in which the cooling in step b) is effected in two or more stages, preferably in two, three or four stages, more preferably in three stages.

Various preferred embodiments of the novel processes are characterized in that the heat required according to step d) to evaporate and then superheat the liquid HCl is provided by the heat obtained in the cooling and at least partial liquefaction of the compressed crude HCl gas in step b).

More preferably, the thermal energy obtainable in step b) is withdrawn from the first and/or second stages of the cooling in step b). The compression a) is performed especially at a pressure of up to 30 bar (30 000 hPa), preferably of up to 20 bar (20 000 hPa), more preferably of up to 15 bar (15 000 hPa).

The cooling in step b) is performed especially down to a temperature of −80° C. and higher, preferably of −70° C. and higher, more preferably of −60° C. and higher.

The evaporation in step d) is performed especially at a temperature of −10° C. and higher, preferably of −20° C. and higher, more preferably of −45° C. and higher.

In various preferred embodiments of the novel process, the crude HCl gas stream in step a) comprises nitrogen and/or other inert gases, for example noble gases and/or other gases which are uncondensable under the process conditions, and these gases are removed from the liquefied hydrogen chloride in step c) with the removal of this gas comprising carbon monoxide.

Various preferred embodiments of the novel processes are characterized in that the cooling in step b) is effected in two or more stages and, before the liquefaction of the hydrogen chloride, condensable organic secondary constituents, especially ortho-dichlorobenzene or monochlorobenzene, are condensed or frozen out and removed from the crude HCl gas stream.

Preference is given to effecting the heat transfer in step b) in a recuperator.

Various particularly preferred embodiments of the novel processes are characterized in that the heat transfer in step b) is effected in a first recuperator in which the purified HCl gas is simultaneously superheated, and which is followed downstream by a second recuperator in which the crude HCl gas is liquefied simultaneously with the evaporation of the purified HCl gas, followed by a postcondenser in which the residual gas remaining after liquefaction of the crude HCl gas is freed of further HCl by condensation.

The invention also includes processes for preparing chlorine from a crude gas comprising hydrogen chloride and carbon monoxide, which comprise: removing gases comprising carbon monoxide, especially nitrogen gas comprising carbon monoxide, from a crude HCl gas comprising at least carbon monoxide with or without nitrogen by the any of the separating processes according to the invention, and catalytically oxidizing the hydrogen chloride in the gas which comprises hydrogen chloride and results from step a) with oxygen to form chlorine.

Preference is given to conducting the oxidation in step B) with pure oxygen, oxygen-enriched air or air.

The hydrogen chloride content in the crude HCl gas which comprises hydrogen chloride and carbon monoxide and enters step a) of the removal A) is preferably in the range from 20 to 99.5% by volume.

The carbon monoxide content in the crude HCl gas which comprises hydrogen chloride and carbon monoxide and enters step a) of the removal A) is preferably in the range of 0.1 to 15% by volume, and particularly preferably 0.5 to 15% by volume.

In various preferred embodiments of the processes of the present invention, the carbon monoxide content in the removal A) is reduced to 1% by volume and less, preferably to less than 0.5% by volume, even more preferably to less than 0.1% by volume.

Preference is further given to a preparation process for chlorine, in which, in step B), at least one optionally supported catalyst is used, which comprises at least one element from the group consisting of: ruthenium (for example in the form of ruthenium oxide, ruthenium chloride or other ruthenium compounds), gold, palladium, platinum, osmium, iridium, silver, copper, potassium, rhenium, chromium.

In a preferred form, the support of the catalyst in step B) is selected from the group consisting of: tin dioxide, titanium dioxide, aluminum oxide, silicon oxide, aluminum-silicon mixed oxides, zeolites, oxides and mixed oxides (for example of titanium, zirconium, vanadium, aluminum, silicon, etc.), metal sulfates, clay, etc., preferably tin dioxide.

Preference is given to combining the novel process with the catalytic gas phase oxidation process known as the Deacon process. In this process, hydrogen chloride is reacted with oxygen in an exothermic equilibrium reaction to give chlorine, which affords steam. The reaction temperature is typically 150 to 500° C.; the customary reaction pressure is 1 to 25 bar. Since it is an equilibrium reaction, it is appropriate to work at minimum temperatures at which the catalyst still has sufficient activity. Moreover, it is appropriate to use oxygen in superstoichiometric amounts relative to the hydrogen chloride. For example a two- to four-fold oxygen excess is customary. Since there is no risk of selectivity losses, it may be economically advantageous to work at relatively high pressure and accordingly at a longer residence time compared to standard pressure.

Suitable preferred catalysts for the Deacon process comprise ruthenium oxide, ruthenium chloride, ruthenium oxide chloride or other ruthenium compounds, on silicon dioxide, aluminum oxide, titanium dioxide, tin dioxide or zirconium dioxide as a support. Suitable catalysts can, for example, be obtained by applying ruthenium chloride to the support and then drying or drying and calcining Suitable catalysts may, in addition to or instead of a ruthenium compound, also comprise compounds of other noble metals, for example gold, palladium, platinum, osmium, iridium, silver, copper or rhenium. Suitable catalysts may further comprise chromium(III) oxide.

The catalytic hydrogen chloride oxidation can be performed adiabatically or isothermally or virtually isothermally, but preferably adiabatically, batchwise or continuously, but preferably continuously, as a moving bed or fixed bed process, preferably as a fixed bed process, in tube bundle reactors or bulk material beds, more preferably in bulk material beds, over heterogeneous catalysts at a reactor temperature of 180 to 500° C., preferably 200 to 400° C., more preferably 220 to 350° C., and a pressure of 1 to 25 bar (1000 to 25 000 hPa), preferably 1.2 to 20 bar, more preferably 1.5 to 17 bar and especially 2.0 to 15 bar.

Customary reaction apparatus in which the catalytic hydrogen chloride oxidation is performed are fixed bed or fluidized bed reactors. The catalytic hydrogen chloride oxidation can preferably also be performed in a plurality of stages.

The conversion of hydrogen chloride in single pass can preferably be limited to 15 to 90%, preferably 40 to 90%, more preferably 50 to 90%. After removal, unconverted hydrogen chloride can be recycled partly or fully into the catalytic hydrogen chloride oxidation. The volume ratio of hydrogen chloride to oxygen at the reactor inlet is preferably 1:2 to 20:1, preferably 1:2 to 8:1, more preferably 1:2 to 5:1.

In adiabatic or virtually adiabatic mode, it is also possible for a plurality of, especially 2 to 10, preferably 4 to 8, more preferably 5 to 7, reactors connected in series with intermediate cooling to be used. In the isothermal or virtually isothermal mode, it is also possible for a plurality of, i.e. 2 to 10, preferably 2 to 6, more preferably 2 to 5, especially 2 to 3, reactors connected in series with additional intermediate cooling to be used. The hydrogen chloride can either be added completely together with the oxygen upstream of the first reactor or distributed over the different reactors. This series connection of individual reactors can also be combined in one apparatus.

A further preferred embodiment of an apparatus suitable for the Deacon process consists in using a structured catalyst bed in which the catalyst activity rises in flow direction. Such a structuring of the catalyst bed can be accomplished through different impregnation of the catalyst supports with active material or through different dilution of the catalyst with an inert material. The inert materials used may, for example, be rings, cylinders or spheres of titanium dioxide, tin dioxide, zirconium dioxide or mixtures thereof, aluminum oxide, steatite, ceramic, glass, graphite, stainless steel or nickel-base alloys. In the case of the preferred use of shaped catalyst bodies, the inert material should preferably have similar external dimensions.

Suitable preferred catalysts for the Deacon process comprise ruthenium oxides, ruthenium chlorides or other ruthenium compounds. Suitable support materials are, for example, silicon dioxide, graphite, titanium dioxide with rutile or anatase structure, tin dioxide, zirconium dioxide, aluminum oxide or mixtures thereof, preferably titanium dioxide, tin dioxide, zirconium dioxide, aluminum oxide or mixtures thereof, more preferably tin dioxide, y- or 6-aluminum oxide or mixtures thereof.

Suitable catalysts can be obtained, for example, by applying ruthenium(III) chloride to the support and then drying or drying and calcining. The catalyst can be shaped after or preferably before the impregnation of the support material. In addition to the ruthenium compound, suitable catalysts may also comprise compounds of other noble metals, for example gold, palladium, platinum, osmium, iridium, silver, copper, chromium or rhenium.

Suitable promoters for doping the catalysts are metals or metal compounds of the metals: alkali metals such as lithium, sodium, potassium, rubidium and cesium, preferably lithium, sodium and potassium, more preferably potassium, alkaline earth metals such as magnesium, calcium, strontium and barium, preferably magnesium and calcium, more preferably magnesium, rare earth metals such as scandium, yttrium, lanthanum, cerium, praseodymium and neodymium, preferably scandium, yttrium, lanthanum and cerium, more preferably lanthanum and cerium, or mixtures thereof.

Suitable shaped catalyst bodies are shaped bodies with any desired shapes, preference being given to tablets, rings, cylinders, stars, wagonwheels or spheres, particular preference being given to rings, cylinders or star extrudates as the form. The shaped bodies can subsequently be dried at a temperature of 100 to 400° C., preferably 100 to 300° C., for example under a nitrogen, argon or air atmosphere, and optionally be calcined. The shaped bodies are preferably first dried at 100 to 150° C. and then calcined at 200 to 400° C.

The heat of reaction of the catalytic hydrogen chloride oxidation can advantageously be utilized to raise high-pressure steam. This can be utilized for operation of a phosgenation reactor and/or of distillation columns, especially of isocyanate distillation columns.

In further steps of the Deacon process, the product gas obtained after the oxidation is cooled in one or more stages, and unconverted hydrogen chloride and water or reaction are removed from the product gas. The unconverted hydrogen chloride and the water of reaction can be removed by condensing aqueous hydrochloric acid out of the product gas stream of the hydrogen chloride oxidation by cooling. Hydrogen chloride can also be absorbed in dilute hydrochloric acid or water. This can be done in one or more stages. In order to remove the hydrogen chloride virtually quantitatively from the product gas, it is particularly advantageous to add water in the last stage in order to achieve countercurrent flow of water and product gas. Optionally, unconverted hydrogen chloride can be recycled into the catalytic hydrogen chloride oxidation. This is followed by drying of the product gas which then still comprises essentially chlorine and oxygen, removal of chlorine from the product gas and recycling the unconverted oxygen which remains thereafter into the hydrogen chloride oxidation.

The invention will now be described in further detail with reference to the following non-limiting examples.

### EXAMPLES

### Example 1

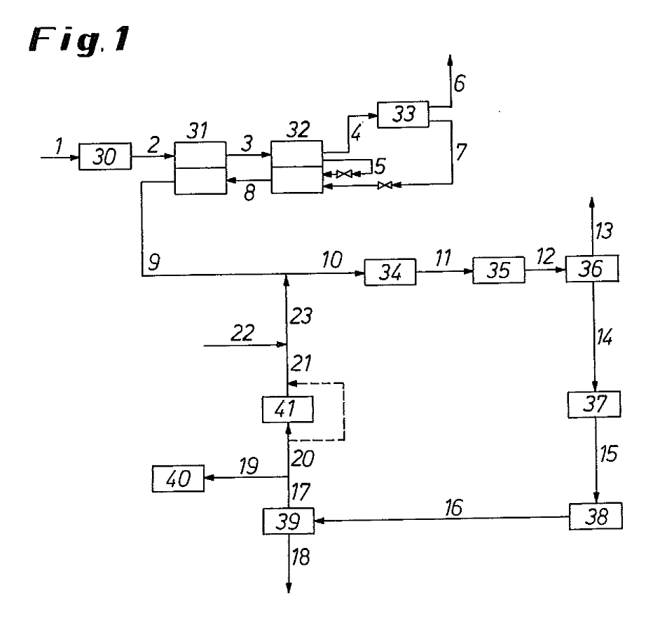

In this example, the advantageous operation of the process according to the invention is described using FIG. 1.

A crude HCl gas stream 1 of 100 kg/h contains 1.5% by volume of CO. Its HCl content is thus approx. 99% by weight. Stream 1 is compressed in a compressor 30 to a pressure of 9 bar.

Subsequently, the compressed crude gas stream 2 is precooled to −10° C. in a heat transferrer 31, which does not yet cause liquefaction. The cooled stream 3 is passed into the recuperator 32 and partly liquefied at −38° C. The nonliquefied fraction 4 contains the main fraction of the CO and unliquefied HCl gas. Stream 4 is passed into the aftercooler 33 and cooled there to −60° C., such that CO remains in gaseous form and is removed from the crude gas stream 4 as stream 6 with residues of HCl gas.

When the crude HCl gas steam contains further components which do not condense under the conditions mentioned, they are also removed. One typical example of such a component is nitrogen.

In the purified, liquefied HCl streams, stream 5 from the recuperator 32 and stream 7 from the aftercooler 33, only small residues of CO are now dissolved. Streams 5 and 7 are decompressed to a pressure of 6 bar. As a result of the lowering of the pressure, a small portion of the liquid streams evaporates, in the course of which their temperature falls below the condensation temperature of the cooled stream 3. Subsequently, the decompressed streams are introduced to the other side of the recuperator 32 and evaporate further. The heat flow required for this purpose is supplied by the partial liquefaction of the stream 3.

Thereafter, the purified, further evaporated HCl stream 8 is passed through the other side of the heat transferrer 31, which completely evaporates and superheats it. At the same time, it precools the compressed crude gas stream 2. The superheated purified HCl gas stream 9 now contains essentially HCl (98 kg/h), while its CO content has been reduced to traces by the above-described purification procedure. It is combined with an oxygen-containing return stream 23 of 95 kg/h to give the reactant stream 10. It is subsequently heated to 290° C. in the heat transferrer 34.

The heated reactant stream 11 in passed into a reaction zone 35, in which, in a cascade of five adiabatically operated reactors with intermediate cooling, 85% of the HCl supplied is converted over a heterogeneous Ru catalyst to Cl₂ and H₂O. At the same time, the CO still present in small residues reacts with oxygen to give CO₂. Since the reaction equilibrium is to the side of the CO₂ product, the CO conversion is virtually quantitative. The intermediate cooling keeps the inlet temperature for each reactor of the cascade at 290° C. Suitable selection of the catalyst material limits the outlet temperature from each reactor to a maximum of 370° C. The maximum outlet temperature is adjusted by regulating the HCl gas stream 9 supplied. When the maximum outlet temperature of 370° C. is exceeded, the HCl gas flow rate 9 is reduced; when the temperature is below the maximum outlet temperature, it is increased.

Unconverted HCl and the majority of the water obtained are removed from the product gas 12 as hydrochloric acid 13 in a separation process 36. Subsequently, it would be possible to contact the hydrochloric acid stream 13 with stream 6 in order to absorb the residues of HCl gas present in the stream 6 in the hydrochloric acid stream 13 and thus to minimize the HCl losses (not shown). Alternatively, a separate absorption with water is also conceivable for stream 6 (likewise not shown).

The remaining gas stream 14 is contacted with sulphuric acid in the next stage 37 and thus dried.

In a chlorine compressor 38, the dried gas stream 15 is compressed to 12 bar.

In a downstream distillation column 39, the dried and compressed gas stream 16 is freed of components such as O₂, and CO₂ formed in the reaction zone (stream 17). The chlorine obtained in the bottoms of this column is drawn off in liquid form as stream 18. The components removed are withdrawn in gaseous form at the top of the column. According to the purity requirements on the chlorine, it may also be sufficient, instead of a distillation, to perform merely a condensation (not shown). This is less complicated in terms of apparatus, but leads to a higher O₂ and CO₂ content in the liquid chlorine.

Downstream of the distillation column 39, a substream 19 of 3 kg/h is discharged from stream 17. This substream still contains approx. 13% by weight of chlorine and therefore has to be conducted into an offgas treatment 40 in order to remove the chlorine.

Since the gas 20 remaining after the discharge is recycled into the process, it should first be freed of components which can deactivate the catalyst in the reaction zone 35. To this end, a gas scrubbing 41 is provided, from which the purified gas stream 21 exits. When the remaining gas 20 does not contain any components which deactivate the catalyst, it can also be conducted past the gas scrubbing 41 (shown with broken lines).

Downstream of the gas scrubbing 41, the purified gas stream 21 is mixed with 21 kg/h of fresh oxygen 22 as a replacement for the oxygen consumed in the process. The mixed stream is then, as described above, combined with the HCl gas stream 9 as return stream 23.

### Example 2 (Comparative Example)

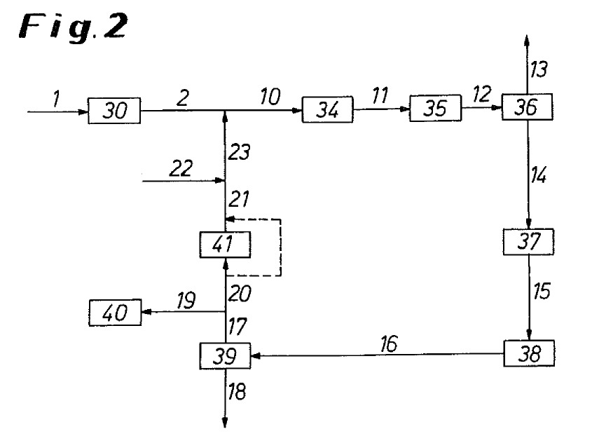

In the comparative example, with reference to FIG. 2, an operating mode without crude HCl gas purification is described, and the economic disadvantage of this process is demonstrated.

A crude HCl gas stream 1 which contains 1.5% by volume of CO is compressed to a pressure of 6 bar in a compressor 30.

Subsequently, the compressed crude gas stream 2 is heated with an oxygen-containing return stream 23 of 95 kg/h to give the reactant stream 10, and heated to 290° C. in the heat transferrer 34.

The heated reactant stream 11 is passed into the same reaction zone 35 as has already been described in Example 1: in a cascade of five adiabatic reactors with intermediate cooling, a portion of the HCl is converted over a heterogeneous Ru catalyst to Cl₂ and H₂O. At the same time, the reaction of the CO present in the HCl gas with oxygen to give CO₂ takes place. The intermediate cooling keeps the inlet temperature for each reactor of the cascade at 290° C. The maximum outlet temperature is kept at 370° C. by regulating the HCl gas stream 2. Since the reaction equilibrium of the CO oxidation which takes place at the same time is to the side of the CO₂ product, the CO conversion is virtually quantitative. Owing to the significantly greater reaction enthalpy of the CO oxidation, the HCl gas stream 2 has to be reduced in order to be able to maintain the desired maximum outlet temperature of 370° C. in the reactors. It falls as a result to 80 kg/h, which corresponds to 80% of the value specified in Example 1. This correspondingly lowers the HCl oxidation capacity of the process significantly, which leads to a serious economic disadvantage.

Unconverted HCl and the majority of the water obtained are removed from the product gas 12 as hydrochloric acid 13 in a separation process 36.

The remaining gas stream 14 is contacted with sulphuric acid in the next stage 37 and thus dried.

In a chlorine compressor 38, the dried gas stream 15 is compressed to 12 bar.

In a downstream distillation column 39, the dried and compressed gas stream 16 is freed of components such as O₂, and CO₂ formed in the reaction zone (stream 17). The chlorine 18 obtained in the bottom of this column is drawn off in liquid form. The components removed are withdrawn in gaseous form at the top of the column. According to the purity requirements on the chlorine, it may also be sufficient here, instead of a distillation, to perform merely a condensation (not shown). This is less complicated in terms of apparatus, but leads to a higher O₂ and CO₂ content in the liquid chlorine.

Downstream of the distillation column 39, a substream 19 of 3 kg/h is discharged from stream 17. This substream still contains chlorine and therefore has to be conducted into an offgas treatment 40 in order to remove the chlorine.

Since the gas 20 remaining after the discharge is recycled into the process, it should first be freed of components which can deactivate the catalyst in the reaction zone 35. To this end, a gas scrubbing 41 is provided, from which the purified gas stream 21 exits. When the remaining gas 20 does not contain any components which deactivate the catalyst, it can also be conducted past the gas scrubbing 41 (shown with broken lines).

Downstream of the gas scrubbing 41, the purified gas stream 21 is mixed with 17 kg/h of fresh oxygen 22 as a replacement for the oxygen consumed in the process. The mixed stream is then, as described above, combined with the HCl gas stream 2 as return stream 23.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A process comprising:
(a) providing a crude HCl gas comprising hydrogen chloride and carbon monoxide;
(b) compressing the crude HCl gas to form a compressed crude HCl gas;
(c) cooling the compressed crude HCl gas to form liquefied hydrogen chloride and a gas comprising carbon monoxide;
(d) separating the liquefied hydrogen chloride and the gas comprising carbon monoxide;
(e) evaporating the liquefied hydrogen chloride to form a purified HCl gas; and
(f) feeding the purified HCl gas to an HCl oxidation process.

2. The process according to claim 1, wherein evaporating the liquefied hydrogen chloride further comprises superheating the liquefied hydrogen chloride.

3. The process according to claim 1, wherein cooling the compressed crude HCl gas is carried out in two or more stages.

4. The process according to claim 1, wherein at least a portion of energy required in evaporating the liquefied hydrogen chloride comprises heat from the cooling of the compressed crude HCl gas.

5. The process according to claim 1, wherein compressing the crude HCl gas is carried out at a pressure of up to 30 bar.

6. The process according to claim 1, wherein cooling the compressed crude HCl gas is carried out at a temperature greater than or equal to −80° C.

7. The process according to claim 5, wherein cooling the compressed crude HCl gas is carried out at a temperature greater than or equal to −80° C.

8. The process according to claim 1, wherein evaporating the liquefied hydrogen chloride is carried out at a temperature greater than or equal to −10° C.

9. The process according to claim 7, wherein evaporating the liquefied hydrogen chloride is carried out at a temperature greater than or equal to −10° C.

10. The process according to claim 1, wherein the crude HCl gas further comprises an inert gas selected from the group consisting of nitrogen, noble gases, and mixtures thereof, and wherein subsequent to the cooling of the compressed crude HCl gas, the inert gas is present in the gas comprising carbon monoxide.

11. The process according to claim 2, wherein cooling the compressed crude HCl gas comprises removing condensable organic compounds comprising ortho-dichlorobenzene, monochlorobenzene or mixtures thereof, prior to forming the liquefied hydrogen chloride.

12. The process according to claim 4, wherein transferring the heat from the cooling of the compressed crude HCl gas to the evaporation of the liquefied hydrogen chloride comprises a recuperator.

13. The process according to claim 4, wherein evaporating the liquefied hydrogen chloride further comprises superheating the liquefied hydrogen chloride.

14. The process according to claim 13, wherein the heat from the cooling of the compressed crude HCl gas is at least partially transferred in a first recuperator wherein the purified HCl gas is superheated, and further transferred downstream in a second recuperator wherein the crude HCl gas is liquefied with the evaporation of the purified HCl gas, further comprising a postcondenser wherein the gas comprising carbon monoxide is treated to remove residual HCl by condensation.

15. A process comprising:
(a) providing a crude HCl gas comprising hydrogen chloride and carbon monoxide;
(b) compressing the crude HCl gas to form a compressed crude HCl gas;
(c) cooling the compressed crude HCl gas to form liquefied hydrogen chloride and a gas comprising carbon monoxide;
(d) separating the liquefied hydrogen chloride and the gas comprising carbon monoxide;
(e) evaporating the liquefied hydrogen chloride to form a purified HCl gas; and
(f) catalytically oxidizing the purified HCl gas with oxygen to form chlorine.

16. The process according to claim 15, wherein hydrogen chloride is present in the crude HCl gas in an amount of 20 to 99.5% by volume.

17. The process according to claim 15, wherein carbon monoxide is present in the crude HCl gas in an amount of 0.1 to 15% by volume.

18. The process according to claim 15, wherein carbon monoxide is present in the purified HCl gas in an amount less than or equal to 1% by volume.

19. The process according to claim 17, wherein carbon monoxide is present in the purified HCl gas in an amount less than 0.1% by volume.

20. The process according to claim 15, wherein catalytically oxidizing the purified HCl gas is carried out in the presence of an optionally supported catalyst, wherein the catalyst comprises a catalytically active material comprising one or more selected from the group consisting of ruthenium, gold, palladium, platinum, osmium, iridium, silver, copper, potassium, rhenium, and chromium, and wherein the optional support material comprises one or more selected from the group consisting of tin dioxide, titanium dioxide, aluminum oxide, silicon oxide, aluminum-silicon mixed oxides, zeolites, mixed oxides, metal sulfates, and clays.
